(19) United States
(12) Patent Application Publication
(10) Pub. No.: US 2022/0156079 A1
(43) Pub. Date: May 19, 2022

(54) PIPELINE COMPUTER SYSTEM AND INSTRUCTION PROCESSING METHOD

(71) Applicant: REALTEK SEMICONDUCTOR CORPORATION, Hsinchu (TW)

(72) Inventor: CHIA-I CHEN, Hsinchu (TW)

(21) Appl. No.: 17/412,296

(22) Filed: Aug. 26, 2021

(30) Foreign Application Priority Data
Nov. 18, 2020 (TW) 109140343

(51) Int. Cl. G06F 9/38

(52) U.S. Cl. CPC G06F 9/3806; G06F 9/3846

(57) ABSTRACT

A pipeline computer system includes a processor circuit and a memory circuit. The processor circuit is configured to obtain a first target address of a first branch instruction and a second address of a first prediction instruction according to a first address of the first branch instruction before the first branch instruction is executed, and sequentially prefetch a first instruction corresponding to the first target address and the first prediction instruction when a prediction result of the first branch instruction is branch-taken, in which an execution of the first instruction is followed by an execution of the first prediction instruction. The memory circuit is configured to store the first instruction and the first prediction instruction.

### BACKGROUND

### 1. Technical Field

The present disclosure relates to a computer system. More particularly, the present disclosure relates to a pipeline computer system having a branch prediction mechanism and an instruction processing method thereof.

### 2. Description of Related Art

Instruction pipeline is able to increase a number of instructions being executed in a single interval. In order to improve efficiency of processing instructions, a branch prediction instruction is utilized to predict an execution result of a branch instruction (e.g., a jump instruction, a return instruction, etc.), in order to move up the processing of a subsequent instruction. However, if the prediction result of the branch is branch-untaken, the current branch prediction mechanism is not able to remove bubbles (i.e., pipeline stalls) in the instruction processing progress.

### SUMMARY

In some aspects, a pipeline computer system includes a processor circuit and a memory circuit. The processor circuit is configured to obtain a first target address of a first branch instruction and a second address of a first prediction instruction according to a first address of the first branch instruction before the first branch instruction is executed, and sequentially prefetch a first instruction corresponding to the first target address and the first prediction instruction when a prediction result of the first branch instruction is branch-taken, in which an execution of the first instruction is followed by an execution of the first prediction instruction. The memory circuit is configured to store the first instruction and the first prediction instruction.

In some aspects, an instruction processing method includes the following operations: obtaining a first target address of a first branch instruction and a second address of a first prediction instruction according to a first address of the first branch instruction before the first branch instruction is executed; and sequentially prefetching a first instruction corresponding to the first target address and the first prediction instruction when a prediction result of the first branch instruction is branch-taken, on which an execution of the first instruction is followed by an execution of the first prediction instruction.

These and other objectives of the present disclosure will be described in preferred embodiments with various figures and drawings.

### BRIEF DESCRIPTION OF THE DRAWINGS

FIG. 1 is a schematic diagram of a pipeline computer system according to some embodiments of the present disclosure.

FIG. 2 is a flow chart of an instruction processing method according to some embodiments of the present disclosure.

FIG. 3A is a schematic diagram showing the pipeline computer system in FIG. 1 that sequentially executes multiple instructions according to some embodiments of the present disclosure.

FIG. 3B is an operation flow of the instructions in FIG. 3A according to some embodiments of the present disclosure.

FIG. 4A is a schematic diagram showing the pipeline computer system in FIG. 1 that sequentially executes multiple instructions according to some embodiments of the present disclosure.

FIG. 4B is an operation flow of the instructions in FIG. 4A according to some embodiments of the present disclosure.

FIG. 5 is a schematic diagram showing the pipeline computer system in FIG. 1 that sequentially executes multiple instructions according to some embodiments of the present disclosure.

### DETAILED DESCRIPTION

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system formed with at least one circuit, and the term “circuit” may indicate an object, which is formed with one or more transistors and/or one or more active/passive elements based on a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, like elements in various figures are designated with the same reference number.

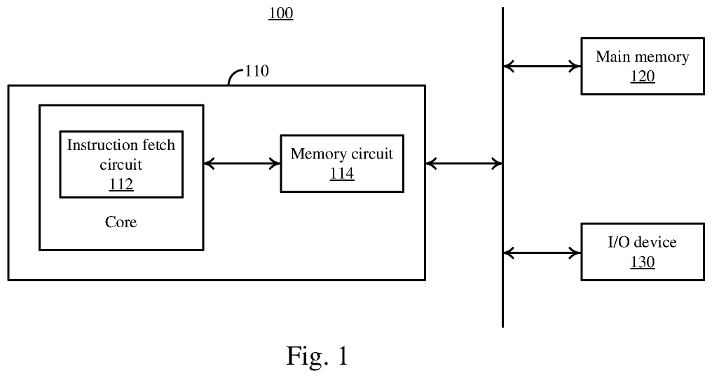

FIG. 1 is a schematic diagram of a pipeline computer system 100 according to some embodiments of the present disclosure. In some embodiments, the pipeline computer system 100 may be applied to a general electronic product (which may include, but not limited to, personal computer, laptop, video card, server, tablet, smart phone, television, network device, and so on). The pipeline computer system 100 includes a processor circuit 110, a main memory 120, and an input/output (I/O) device 130. The main memory 120 is configured to store instruction(s) and/or data. The I/O device 130 may receive (or output) instruction(s) (or data).

In some embodiments, the processor circuit 110 may be a pipeline processor circuit, which may allow overlapping execution of multiple instructions. For example, the processor circuit 110 may include a program counter circuit (not shown), an instruction memory (not shown), at least one multiplexer circuit (not shown), at least one register (not shown), and at least one of data memory circuit (not shown) which form data paths for parallel processing multiple instructions. The arrangements about the data paths in the processor circuit 110 are given for illustrative purposes, and the present disclosures is not limited thereto.

In some embodiments, a core of the processor circuit 110 includes an instruction fetch circuit 112 and the processor circuit 110 may further include a memory circuit 114. The instruction fetch circuit 112 may be configured to determine whether a prediction result of a branch instruction is branch-taken or branch-untaken, and prefetch a corresponding instruction from the main memory 120 (or the memory circuit 114) according to the prediction result. In some embodiments, the instruction fetch circuit 112 includes a branch prediction mechanism (not shown), which is configured to determine the prediction result and store a lookup table (e.g., table 1 and table 2 discussed below). In some embodiments, the branch prediction mechanism may determine the prediction result of a current branch instruction according to a history about executions of previous instructions. In some embodiments, the branch prediction mechanism may perform a global-sharing (g-share) algorithm or a tagged geometric history length branch prediction (TAGE) algorithm, in order to determine the prediction result of the branch instruction. The types of the algorithms are given for illustrative purposes, and the present disclosure is not limited thereto. Various algorithms able to execute branch prediction are within the contemplated scope of the present disclosure. Operations about the branch prediction and the prefetching instructions will be described in the following paragraphs.

In some embodiments, the memory circuit 114 may be a register, which is configured to store instruction(s) and/or data prefetched by the instruction fetch circuit 112. In some embodiments, the memory circuit 114 may be a cache memory, which may include entire cache memory levels. For example, the memory circuit 114 may only include a L1 cache memory, or may include a L1 cache memory and a L2 cache memory, or may include a L1 cache memory, a L2 cache memory, and a L3 cache memory. The types of the memory circuit 114 are given for illustrative purposes, and the present disclosure is not limited thereto.

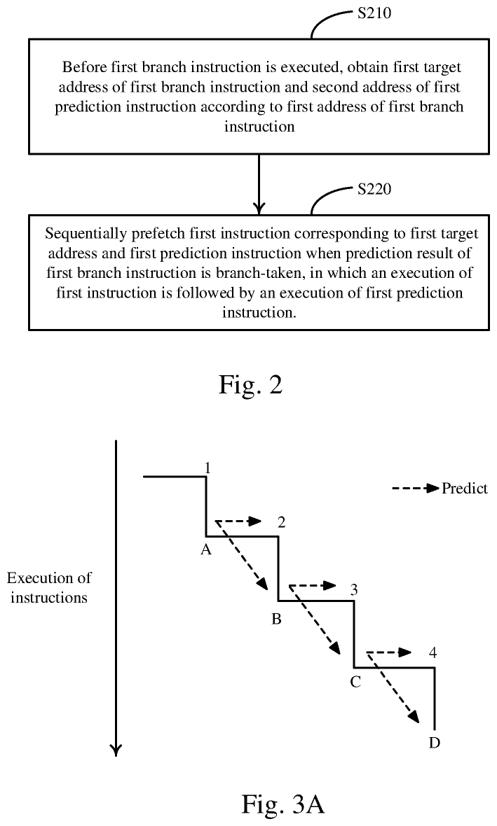

FIG. 2 is a flow chart of an instruction processing method 200 according to some embodiments of the present disclosure. In some embodiments, the instruction processing method 200 may be (but not limited to) performed by the processor circuit 110 in FIG. 1.

In operation S210, before a first branch instruction (e.g., branch instruction B) is executed, a first target address (e.g., an address ADDR₃ in table 1) of the first branch instruction and a second address (e.g., an address ADDR_{C} in table 1) of a first prediction instruction (e.g., branch instruction C) are obtained according to a first address (e.g., an address ADDR_{B} in table 1) of the first branch instruction. In operation S220, a first instruction corresponding to the first target address and the first prediction instruction are sequentially prefetched when a prediction result of the first branch instruction is branch-taken, in which an execution of the first instruction is followed by an execution of the first prediction instruction.

The above description of the instruction processing method 200 includes exemplary operations, but the operations are not necessarily performed in the order described above. Operations of the instruction processing method 200 may be added, replaced, changed order, and/or eliminated as appropriate, or the operations are able to be executed simultaneously or partially simultaneously as appropriate, in accordance with the spirit and scope of various embodiments of the present disclosure.

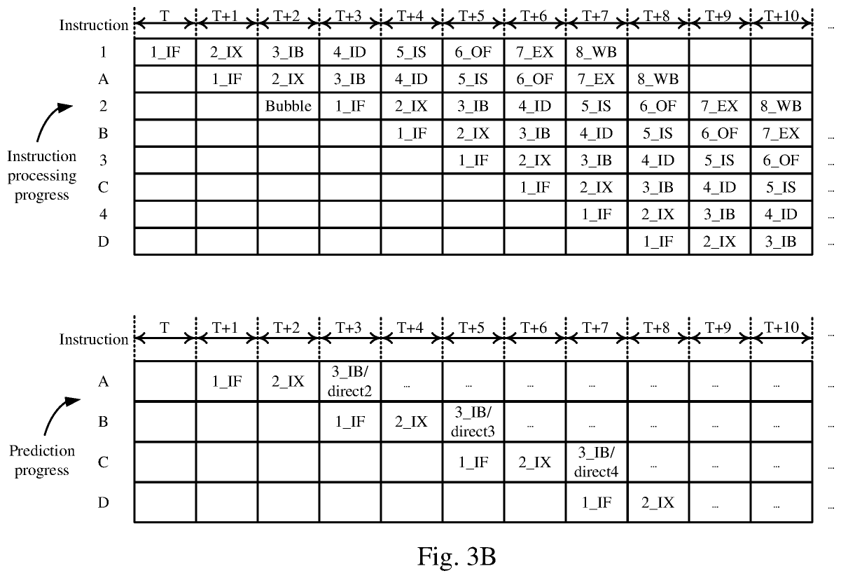

In order to further illustrate the instruction processing method 200, reference is now made to FIG. 3A and FIG. 3B. FIG. 3A is a schematic diagram showing the pipeline computer system 100 in FIG. 1 that sequentially executes multiple instructions according to some embodiments of the present disclosure, and FIG. 3B is an operation flow of the instructions in FIG. 3A according to some embodiments of the present disclosure.

As shown in FIG. 3A, from the top to the bottom, the processor circuit 110 sequentially executes instructions 1, A, 2, B, 3, C, 4, and D. In this example, it is assumed that the instructions A, B, C, and D are branch instructions, the instruction 2 is an instruction corresponding to a target address of the instruction A, the instruction 3 is an instruction corresponding to a target address of the instruction B, and the instruction 4 is an instruction corresponding to a target address of the instruction C. In some embodiments, the branch instruction may be, but not limited to, a conditional branch instruction and/or an unconditional branch instruction.

As described above, the processor circuit 110 stores a lookup table. In some embodiments, the lookup table is configured to store a corresponding relation among the first address, the first target address, and the second address. For example, the lookup table may be expressed as the following table 1:

| Address of branch | Target address of | Address of next |
|---|---|---|
| instruction | branch instruction | prediction instruction |
| ADDR_{A} | ADDR₂ | ADDR_{B} |
| ADDR_{B} | ADDR₃ | ADDR_{C} |
| ADDR_{C} | ADDR₄ | ADDR_{D} |
| ADDR_{C}′ | ADDR₄′ | ADDR_{D}′ |

In table 1, the address (i.e., the first address) of the branch instruction indicates a memory address of the main memory 120 (or the memory circuit 114) where the branch instruction is stored. The target address (i.e., the first target address) of the branch instruction is to indicate a memory address where an instruction, which is to be executed when the prediction result of the branch instruction is branch-taken, is stored. The execution of the instruction corresponding to the target address is followed by the execution of the next prediction instruction. For example, the instruction 2 corresponds to the target address ADDR₂, and the next prediction instruction is the instruction B that is executed after the execution of the instruction 2. As a result, when the processor circuit 110 executes the branch instruction A, the instruction fetch circuit 112 may search the lookup table according to the memory address ADDR_{A} of the branch instruction A, in order to obtain the target address ADDR₂ and the address ADDR_{B} of the next prediction instruction (i.e., the branch instruction B). In other words, the address of the branch instruction is considered as a tag of the lookup table. If the tag of the lookup table is hit, it indicates that the processor circuit 110 is executing the branch instruction corresponding to the tag, and the processor circuit 110 may obtain the corresponding target address and the memory address (i.e., the second address) of the next prediction instruction. As shown in FIG. 3A, the instruction fetch circuit 112 may predict (as shown with dotted lines) the target address and the address of the next prediction instruction according to the address of the branch instruction.

In different embodiments, the address of the next prediction instruction in table 1 may be an offset value or an absolute address. If the address of the next prediction instruction is the offset value, the processor circuit 110 may sum up the corresponding target address and the corresponding offset value to determine the actual memory address of the next prediction instruction.

In some embodiments, as shown in FIG. 3B, an instruction processing progress of the pipeline computer system 100 may include multiple stages, which sequentially include instruction fetch (labeled as 1_IF), instruction tag compare (labeled as 2_IX), instruction buffering (labeled as 3_IB), instruction decode (labeled as 4_ID), instruction issue (labeled as 5_IS), operand fetch (labeled as 6_OF), execution (labeled as 7_EX), and writeback (labeled as 8_WB). The number of stages in the instruction processing progress are given for illustrative purposes, and the present disclosures is not limited thereto. In some embodiments, before the processor circuit 110 processes the branch instruction (e.g., the branch instruction B) in the first stage (i.e., 1_IF), the instruction fetch circuit 112 may start determining the prediction result of the branch instruction, and search the lookup table (e.g., table 1) according to the address of the branch instruction, in order to obtain the target address of the branch instruction and the address of the next prediction instruction. If the prediction result is branch-taken, the processor circuit 110 may prefetch the corresponding instruction (e.g., the instruction 3) corresponding to the target address in the third stage (i.e., 3_IB). Afterwards, the processor circuit 110 may prefetch the next prediction instruction (e.g., the branch instruction C) in the fourth stage (i.e., 4_ID). It is understood that, according to different hardware architecture, the processor circuit 110 (and/or the instruction fetch circuit 112) may prefetch the instruction corresponding to the target address and the next prediction instruction in a prior stage or a later stage.

In greater detail, during an interval T, the processor circuit 110 starts processing the instruction 1. During an interval T+1, the processor circuit 110 starts processing the branch instruction A, and the instruction fetch circuit 112 starts determining the prediction result of the branch instruction A. Meanwhile, the instruction fetch circuit 112 reads the lookup table according to the address ADDR_{A}, in order to obtain the target address ADDR₂ and the address ADDR_{B} of the next prediction instruction (i.e., operation S210 in FIG. 2).

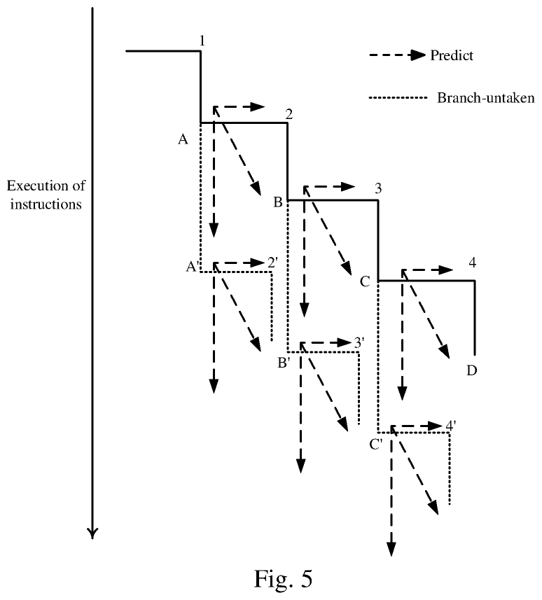

During an interval T+2, as the determination of whether the branch instruction A is branch-taken is not completed, the processor circuit 110 starts processing a next instruction of the branch instruction A (e.g., instruction A′ in FIG. 5). In this example, the prediction result of the branch instruction A is branch-taken, and thus the processor circuit 110 may flush the next instruction. Under this condition, a bubble is generated in the interval T+2.

During the interval T+3, the instruction fetch circuit 112 determines that the prediction result of the branch instruction A is branch-taken (labeled as 3_IB/direct2). In response to this prediction result, the processor circuit 110 may prefetch the instruction 2 according to the target address ADDR₂ (i.e., operation S220). Meanwhile, if the next prediction instruction (i.e., instruction B) corresponding to the address ADDR_{B} is a branch instruction, the instruction fetch circuit 112 may start determining the prediction result of the branch instruction B, and read the lookup table according to the address ADDR_{B} of the branch instruction B, in order to obtain the address ADDR₃ and the address ADDR_{C} of the next prediction instruction (i.e., branch instruction C) (i.e., operations S210 in FIG. 2).

During an interval T+4, the processor circuit 110 starts processing the branch instruction B (i.e., operation S220 in FIG. 2). In other words, the prediction result of the branch instruction is started to be determined in one interval (i.e., interval T+3) prior to the branch instruction B being executed (i.e., the interval T+4).

During an interval T+5, the instruction fetch circuit 112 determines that the prediction result of the branch instruction B is branch-taken (labeled as 3_IB/direct3). In response to the prediction result, the processor circuit 110 may start processing (i.e., prefetching) the instruction 3 according to the address ADDR₃ (i.e., operation S220 in FIG. 2). In other words, after the instruction B is executed, the processor circuit 110 may prefetch the instruction 3 without causing time delay (i.e., no bubble is caused). Meanwhile, as the next prediction instruction corresponding to the address ADDR_{C} is the branch instruction C, the instruction fetch circuit 112 may start determining the prediction result of the branch instruction C, and read the lookup table according to the address ADDR_{C}, in order to obtain a target address ADDR₄ and the address ADDR_{D} of the next prediction instruction (i.e., the branch instruction D) (i.e., operation S210 in FIG. 2). During an interval T+6, the processor circuit 110 prefetches the branch instruction C corresponding to the address ADDR_{C}, in order to start processing the branch instruction C (i.e., operation S220 in FIG. 2). In other words, from the interval T+4 to the interval T+6, the processor circuit 110 is able to sequentially execute the branch instruction B, the instruction 3, and the branch instruction C without causing bubble(s). With the same analogy, from the interval T+7 to the interval T+10, if the prediction results of the subsequent branch instructions C and D are all branch-taken, the bubble(s) in the processing progress can be removed.

In some related approaches, a branch prediction mechanism only prefetches the target address when the prediction result is branch-taken according to the address of the branch instruction. In the above approaches, even if the prediction result of the branch instruction is branch-taken, and one bubble is caused before the instruction corresponding to the target bit is executed. Compared with the above approaches, with the arrangement shown in table 1, most bubbles in the instruction processing progress can be removed. As a result, the instruction processing efficiency of the processor circuit 110 are improved.

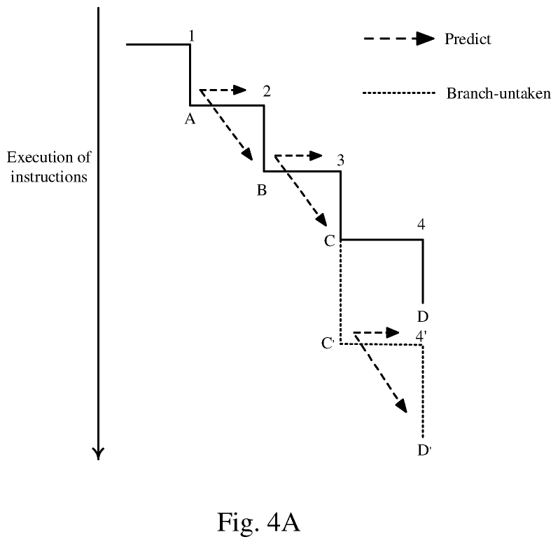

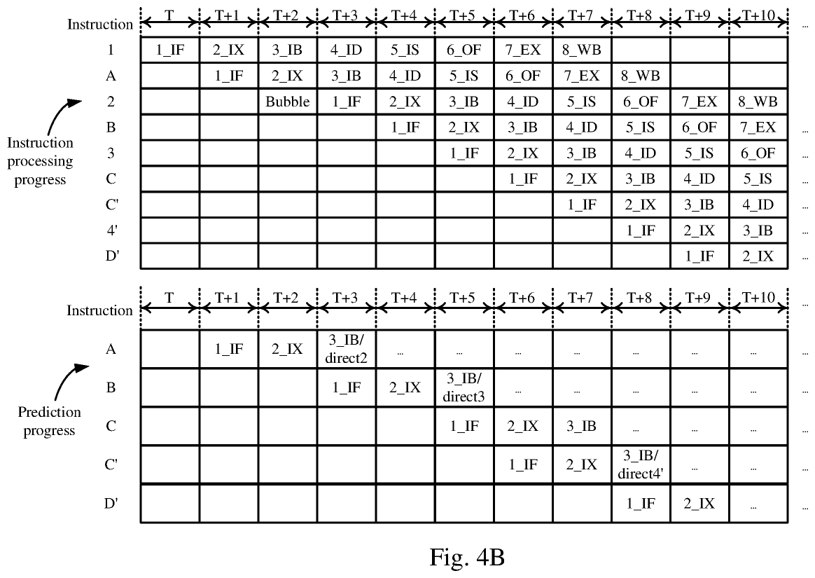

Reference is made to FIG. 4A and FIG. 4B. FIG. 4A is a schematic diagram showing the pipeline computer system 100 in FIG. 1 that sequentially executes multiple instructions according to some embodiments of the present disclosure. FIG. 4B is an operation flow of the instructions in FIG. 4A according to some embodiments of the present disclosure.

In this example, operations of processing the instruction 1, the branch instruction A, the instruction 2, the branch instruction B, and the instruction 3 are the same as those in FIG. 3B, and thus the repetitious descriptions are not further given. During the interval T+5, the instruction fetch circuit 112 starts determining the prediction result of the branch instruction C, and reads the lookup table according to the address ADDR_{C} of the branch instruction C, in order to obtain the target address ADDR₄ and the address ADDR_{D} of the next prediction instruction (i.e., operation S210 in FIG. 2). During an interval T+6, the processor circuit 110 starts processing the branch instruction C. Meanwhile, the instruction fetch circuit 112 starts determining the prediction result of a branch instruction C′, and reads the lookup table according to an address ADDR_{C′} of the branch instruction C′, in order to obtain a target address ADDR_{4′} and an address ADDR_{D′} of the next prediction instruction (i.e., the branch instruction D′) (i.e., operation S210 in FIG. 2). It is understood that, an execution of the branch instruction C is followed by an execution of the branch instruction C′, and an execution of an instruction 4′ corresponding to the target address ADDR_{4′} is followed by an execution of the branch instruction D′. During an interval T+7, the instruction fetch circuit 112 determines that the prediction result of the branch instruction C is branch-untaken. Therefore, the processor circuit 110 starts processing (i.e., sequentially prefetching) the branch instruction C′ during the interval T+7. During an interval T+8, the instruction fetch circuit 112 determines that the prediction result of the branch instruction C′ is branch-taken (labeled as 3_IB/direct4′), and searches the lookup table according to an address ADDR_{D′} of a branch instruction D′, in order to obtain the corresponding target address and the address of the next prediction instruction (not shown) (i.e., operation S210 in FIG. 2). Meanwhile, the instruction fetch circuit 112 may start determining the prediction result of the branch instruction D′ during the interval T+8. The processor circuit 110 may prefetch the instruction 4′ during the interval T+8, and prefetch the branch instruction D′ during an interval T+9. In other words, in this example, on condition that the prediction result of the branch instruction C is branch-untaken, the processor circuit 110 is able to sequentially execute the branch instruction C′, the instruction 4′, and the branch instruction D′ without cause bubble(s).

In the above related approaches, if the prediction result of the branch instruction is branch-untaken, at least one bubble is caused. In some other approaches, the branch prediction mechanism obtains a target address of a next branch instruction according to a target address a branch instruction (if the prediction result is branch-taken). In above approaches, if the prediction result is branch-untaken, multiple (e.g., four) bubbles are caused. Compared to those approaches, with the arrangements in table 1, when the prediction result of the branch instruction is branch-untaken, the processor circuit 110 is able to execute multiple instruction without causing bubble(s).

Reference is made to FIG. 5. FIG. 5 is a schematic diagram showing the pipeline computer system 100 in FIG. 1 that sequentially executes multiple instructions according to some embodiments of the present disclosure. In some embodiments, the processor circuit 110 is further configured to obtain an address of another prediction instruction (e.g., a branch instruction A′) according to an address of a branch instruction (e.g., the branch instruction A), and to start processing the prediction instruction A′ when the prediction result of the branch instruction A is branch-untaken. In other words, compared with FIG. 3A or FIG. 4A, the instruction fetch circuit 112 may predict the target address, the address of the next prediction instruction (if the prediction result is branch-taken), and the address of the next prediction instruction (if the prediction result is branch-untaken).

In examples of FIG. 5, the lookup table may be expressed as the following table 2:

| | Target | Address of next | Address of next |
|---|---|---|---|
| Address | address | prediction instruction | prediction instruction |
| of branch | of branch | (if prediction result is | (if prediction result is |
| instruction | instruction | branch-taken) | branch-untaken) |
| ADDR_{A} | ADDR₂ | ADDR_{B} | ADDR_{A}′ |
| ADDR_{B} | ADDR₃ | ADDR_{C} | ADDR_{B}′ |
| ADDR_{C} | ADDR₄ | ADDR_{D} | ADDR_{C}′ |
| ADDR_{A}′ | ADDR₂′ | . . . | . . . |
| ADDR_{B}′ | ADDR₃′ | . . . | . . . |
| ADDR_{C}′ | ADDR₄′ | . . . | . . . |

In other words, in this example, the lookup table (i.e., table 2) is further configured to store a corresponding relation among the address of the branch instruction, the target address of the branch instruction, the address of the next prediction address (if the prediction result is branch-taken), and the address of the next prediction address (if the prediction result is branch-untaken).

For example, before the processor circuit 110 starts processing the branch instruction A, the instruction fetch circuit 112 may start determining the prediction result of the branch instruction A according to the address ADDR_{A} according to the branch instruction A, and obtain the corresponding target address ADDR₂, the address ADDR_{B} of the next prediction instruction B (if the prediction result of is branch-taken) and the address ADDR_{A′} of the next prediction instruction A′ (if the prediction result of is branch-untaken) from table 2. With this analogy, if the prediction result of the branch instruction A is branch-untaken, the processor circuit 110 (and the instruction fetch circuit 112) may obtain a target address ADDR_{2′} of the branch instruction A′, an address (not shown) of a next prediction instruction (if the prediction result is branch-taken), and an address (not shown) of a next prediction instruction (if the prediction result is branch-untaken) according to the address ADDR_{A′}. As a result, if the prediction result is branch-untaken, the processor circuit 110 (and the instruction fetch circuit 112) may start processing (i.e., prefetch) a corresponding next prediction instruction, in order to remove more bubbles.

As described above, with the pipeline computer system and the instruction processing method in some embodiments, bubbles in the instruction processing progress can be removed, in order to improve overall efficiency of processing instructions.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A pipeline computer system, comprising:
a processor circuit configured to obtain a first target address of a first branch instruction and a second address of a first prediction instruction according to a first address of the first branch instruction before the first branch instruction is executed, and sequentially prefetch a first instruction corresponding to the first target address and the first prediction instruction when a prediction result of the first branch instruction is branch-taken, wherein an execution of the first instruction is followed by an execution of the first prediction instruction; and
a memory circuit configured to store the first instruction and the first prediction instruction.

2. The pipeline computer system of claim 1, wherein the processor circuit is configured to search a lookup table according to the first address to obtain the first target address and the second address, and the lookup table is configured to store a corresponding relation among the first target address, the first target address, and the second address.

3. The pipeline computer system of claim 1, wherein the processor circuit is further configured to obtain a second target address of a second branch instruction and a fourth address of a second prediction instruction according to a third address of a second branch instruction, an execution of the first branch instruction is followed by an execution of the second branch instruction, and if the prediction result is branch-untaken, the processor circuit is further configured to start processing the second branch instruction.

4. The pipeline computer system of claim 1, wherein an execution of an instruction corresponding to the second target address is followed by an execution of the second prediction instruction.

5. The pipeline computer system of claim 1, wherein the prediction result of the first branch instruction is started to be determined in one interval prior to the first branch instruction being executed.

6. The pipeline computer system of claim 1, wherein the processor circuit is further configured to obtain a third address of a second prediction instruction according to the first address, and start processing the second prediction instruction when the prediction result is branch-untaken.

7. The pipeline computer system of claim 6, wherein the processor circuit is configured to search a lookup table according to the first address to obtain the first target address, the second address, and the third address, and the lookup table is configured to store a corresponding relation among the first address, the first target address, the second address, and the third address.

8. An instruction processing method, comprising:
obtaining a first target address of a first branch instruction and a second address of a first prediction instruction according to a first address of the first branch instruction before the first branch instruction is executed; and
sequentially prefetching a first instruction corresponding to the first target address and the first prediction instruction when a prediction result of the first branch instruction is branch-taken, wherein an execution of the first instruction is followed by an execution of the first prediction instruction.

9. The instruction processing method of claim 8, further comprising:
obtaining a second target address of a second branch instruction and a fourth address of a second prediction instruction according to a third address of a second branch instruction, wherein an execution of the first branch instruction is followed by an execution of the second branch instruction; and
if the prediction result is branch-untaken, starting processing the second branch instruction.

10. The instruction processing method of claim 9, wherein an execution of an instruction corresponding to the second target address is followed by an execution of the second prediction instruction,

11. The instruction processing method of claim 8, further comprising:
obtaining a third address of a second prediction instruction according to the first address; and
starting processing the second prediction instruction when the prediction result is branch-untaken.

12. The instruction processing method of claim 11, wherein obtaining the third address of the second prediction instruction according to the first address comprises:
searching a lookup table according to the first address to obtain the first target address, the second address, and the third address,
wherein the lookup table is configured to store a corresponding relation among the first address, the first target address, the second address, and the third address.

13. The instruction processing method of claim 8, wherein the prediction result of the first branch instruction is started to be determined in one interval prior to the first branch instruction being executed.

14. The instruction processing method of claim 8, wherein obtaining the first target address of the first branch instruction and the second address of the first prediction instruction according to the first address of the first branch instruction before the first branch instruction is executed comprises:
searching a lookup table according to the first address to obtain the first target address and the second address,
wherein the lookup table is configured to store a corresponding relation among the first target address, the first target address, and the second address.
